(19) United States
(12) Patent Application Publication
(10) Pub. No.: US 2003/0141971 A1
(43) Pub. Date: Jul. 31, 2003

(54) Electronic emergency incident notification system

(76) Inventor: Edward Daniel Heiken JR., Biloxi, MS (US)

Correspondence Address: Clinton R. Stuart, P.O. Box 4412, Baton Rouge, LA, 70821-4412, US

(21) Appl. No.: 10/146,969

(22) Filed: May 16, 2002

Related U.S. Application Data
(60) Provisional application No. 60/351,973, filed on Jan. 25, 2002.

(51) Int. Cl. G08B 29/00

(52) U.S. Cl. 340/506; 340/531; 340/539.17; 379/49

(57) ABSTRACT

The present invention is an electronic emergency incident notification system (“EEINS”) which allows subscribers to transmit notification of a nuclear/chemical/biological release to a central server for transmittal to the appropriate governmental agencies. In the preferred embodiment, a subscriber would utilize a user interface device to transmit spatial data and an incident report to the central server, typically using the Internet. The central server would map the spatial data onto a GIS database to determine which agencies require notification, and would then transmit the incident report to the receiving nodes at the appropriate agencies. At the local level, the receiving node may include software to automatically activate the appropriate public warning systems. The EEINS is sufficiently flexible to service both fixed and mobile sites.

### BACKGROUND OF THE INVENTION

The present invention relates generally to an automated electronic system for improved notification of various authorities and agencies in cases of emergency incidents, and shall be termed an Electronic Emergency Incident Notification System (“EEINS”). Emergency incidents would include nuclear, chemical, or biological releases which could threaten public health and safety and which may require immediate response by several different agencies, including perhaps local, state, and federal emergency response agencies, for simultaneous, cooperative efforts. Furthermore, state and federal laws require notification of various agencies (such as the National Response Center (“NRC”), the local Emergency Operation Committee (“EOC”)/Local Emergency Planning Committee (“LEPC”) for the affected area, and the state environmental department) in response to certain types of emergency incidents, and the EEINS is designed to facilitate the simultaneous notification of all such agencies. An example of an incident which might be reported using the EEINS would be an accidental chemical discharge from a fixed chemical plant, but the EEINS could also be used to report incidents occurring during transportation of dangerous materials, such as a chemical leak from a truck, train, or barge hauling chemicals.

The EEINS may also include an automated public warning system for activating the appropriate channels for alerting the general public of a dangerous incident and of the appropriate response. While the present invention is particularly well-suited for use by industries who may need to notify government agencies of nuclear, chemical, or biological releases, it is in no sense limited to this application. These and other uses will be apparent to those skilled in the art field.

In the case of any unauthorized release of a regulated substance (such as oil, chemicals, biological agents, or radioactive materials), industry is required by law to immediately report the release to the local EOC/LEPC for the affected area (who will then notify the appropriate emergency response personnel) and the NRC (who will determine if a federal response is required and then coordinate the various federal agencies which may have a role in containing the release). State law may require further notifications, such as the state police, HazMat Response Units, the state environmental department, local public health officials, and local fire and rescue departments. Under the current system, the personnel at the industrial site of the release would, at the time of an incident, first have to determine precisely which agencies to notify (based upon geographic jurisdiction and the type of incident), and would then have to independently contact each agency via telephone. Although each agency would require essentially the same information from the industrial site, the current system requires the personnel at the industrial site to verbally provide the information to each agency. Thus, under the current system, notification occurs one at a time, in a sequential manner.

The sequential nature of the current system slows the response time of the agencies and occupies the personnel at the industrial site who could be used instead to directly address the release (i.e. to stop any additional leaks and to initiate cleanup procedures). It also involves a high degree of human error since it requires the personnel at the industrial site to make decisions quickly while under stress, while also requiring repeated oral reports to various agencies (which could lead to different agencies receiving differing information). Further human error and delay may also be introduced as the agencies attempt to decide which members of the public should be notified and then attempt to activate the various different public warning systems independently. Finally, the current system does not address incidents occurring at mobile sites (such as transportation of chemicals), since the location of such mobile sites at the time of an incident would be unknown.

Obviously, the current system has several drawbacks. The EEINS is designed to correct several of these problems in order to improve emergency notification and response in cases of nuclear/biological/chemical release. First, the EEINS allows the personnel at the industrial site to enter the report information one single time for simultaneous transmission to all appropriate agencies. This simultaneous notification system eliminates much of the delay in notifying the various agencies, ensures that all agencies receive the same information, and frees personnel at the industrial site to respond to the crisis directly. The EEINS also speeds notification by automatically determining and providing required background geographical information to agencies, rather than requiring personnel at the industrial site to repeatedly provide this information to various agencies in the midst of the incident. Human error is also reduced by allowing the industrial sites to enter much of the required information during setup, such that accurate information can be entered in a less stressful environment.

Additionally, the EEINS relieves personnel at the industrial site of the release from the burden of deciding precisely which agencies should be notified in the midst of an incident. Rather, the EEINS automatically determines the list of possible agencies based upon the spatial geometry of the incident and notifies all such agencies, shifting the ultimate decision-making process away from the industrial site towards the agencies. The EEINS may also incorporate the capabilities of distributed GIS databases. One such use of a distributed GIS database, for example, might be to have the EEINS automatically activate all of the appropriate public warning systems (TV and radio alerts, sirens, etc.) for the affected area of the incident, providing a uniform message. The EEINS also provides automatic storage of reported information, which may be helpful in tracking and analyzing prior responses so that agencies may hone response mechanisms. Finally, the EEINS may also be used to report incidents occurring during transport, providing an integrated emergency notification system for incidents occurring at both fixed and mobile sites.

### SUMMARY OF INVENTION

The Electronic Emergency Incident Notification System (“EEINS”) is basically comprised of a user interface device, a central server, and receiving nodes at the agencies to be notified. The user interface device is typically located at each of the industrial sites at issue, and allows the industrial subscriber to interact with the central server. While the central server could service only a single industrial site and could be located on site, more typically the central server will be located at a remote location and will be accessible to several different and geographically separate industrial subscriber sites. In other words, the central server acts as a communications nexus, with several different industrial sites subscribing to the electronic emergency notification services available therein. The central server houses mapping software and database information, namely a geographic information system (“GIS”) database, and one or more means for notifying various agencies of an incident.

Prior to any incident, the subscriber sets up an account with the central server. This account will typically be assigned a user identification name or number and a password for identifying the specific subscriber and ensuring secure access, and will allow the subscriber to pre-enter as much pertinent information as possible in order to facilitate speedy and accurate reporting. For example, the subscriber's address and telephone number may be pre-entered, along with a listing of the chemicals on site which could be released, and all possible agencies which may need to be notified in case of an incident. The subscriber may also pre-select the location of the center of the spatial grid (typically a pinwheel) for reporting the specific geographic location of any incident.

When an incident (such as an accidental discharge of chemicals from a subscriber facility) occurs, the subscriber in question employs a user interface device to connect to the central server. The subscriber then completes an incident report (which includes spatial data about the affected area, information about the type of chemicals released, etc.) and transmits the necessary details to the central server for dissemination to the appropriate agencies. The central server maps the spatial data regarding the affected area onto the GIS database to determine which specific agencies (out of those pre-selected by the subscriber) should be notified, and then transmits the incident report and spatial data to the appropriate agencies.

Each agency then reviews the incident report and determines if this is the type of incident to which they should respond. In more advanced systems, the receiving agencies may also employ a GIS database in order to integrate the incident report notification from the central server and the public warning systems for notifying the general public of steps to take in response to any danger. In such a case, the spatial data will be mapped onto the agency's GIS database and will automatically activate the appropriate public warning systems (i.e. public alert devices, such as sirens, will only be activated within the appropriate affected area). Such a distributed GIS database system, with GIS databases located at receiving agencies, may also be used in other settings in order to allow the various agencies to access their own geographically oriented information based upon the spatial data from the subscriber.

Typically, the user interface device is a personal computer with a web browser for connecting to the central server using the Internet. Thus, data entry typically takes place on web pages operating on the central server. The EEINS is generally used for fixed location sites, such as chemical or nuclear plants. However, the EEINS may also be used for mobile sites to notify agencies of incidents occurring during transport. Specifically, this may be accomplished by using a global positioning device (“GPS”) in conjunction with some sort of wireless communication device for the user interface.

It is an object of this invention to allow subscribers to simultaneously notify all appropriate agencies in case of a chemical, biological, or nuclear incident. It is another object of this invention to allow a subscriber to identify the affected area, so that the spatial data may be used to identify the appropriate receiving parties, such as government agencies, for notification. It is still another object of this invention to maintain a GIS database which includes relevant information for determining which agencies should be notified for an incident in a particular case. It is yet another object of this invention to shift the decision-making process about which agencies should be notified away from the personnel at the site of the incident at the time of the incident. It is yet another object of this invention to reduce the human error in reporting incidents.

It is yet another object of this invention to implement a distributed GIS database system, whereby each agency's detailed geographic information is located at the receiving node for the agency rather than at some central location, allowing each agency to maintain and update its own information while speeding the notification process by reducing the amount of information transmitted by the central server to the receiving nodes. It is yet another object of this invention to allow agencies to use the spatial data to automatically activate the appropriate public warning systems. It is yet another object of this invention to allow for speedy and accurate notification of incidents involving mobile sites, such as during transportation of chemical, biological, or nuclear substances. It is yet another object of this invention to store information regarding reported incidents for analysis at a later date. It is yet another object of this invention to utilize the Internet as the principal means for transmitting notification of incidents, since its dispersed nature makes it resilient and aids in the speedy transmittal of simultaneous notifications. It is yet another object of this invention to utilize a central server to service several different subscribers in order to reduce the hardware, personnel, and maintenance costs for operating the EEINS. These and other objects will be readily apparent to those persons skilled in the art field.

### BRIEF DESCRIPTION OF DRAWINGS

Reference will be made to the drawings where like elements are designated by like numerals and wherein:

FIG. 1 is a schematic diagram of the EEINS, demonstrating the various levels of the system and the flow of information within the system;

FIG. 2 is an illustrative diagram of the elements of a typical EEINS;

FIG. 3 is an example of a user interface for the preferred embodiment of the EEINS where the subscriber may select a polygon indicating the spatial data for the affected area of the incident;

FIG. 4 is an example of a user interface for the preferred embodiment of the EEINS where the subscriber has selected a more complex polygon indicating the spatial data for the affected area of the incident;

FIG. 5 is an example of a user interface for the preferred embodiment of the EEINS where the subscriber may enter data about the incident in report form for transmission to relevant agencies; and

FIG. 6 is an example of a user interface for the preferred embodiment of the EEINS allowing agencies to integrate the spatial data from the subscriber with an automated public warning system in order to trigger the appropriate channels for public warning in the appropriate areas.

### DETAILED DESCRIPTION OF PREFERRED EMBODIMENT

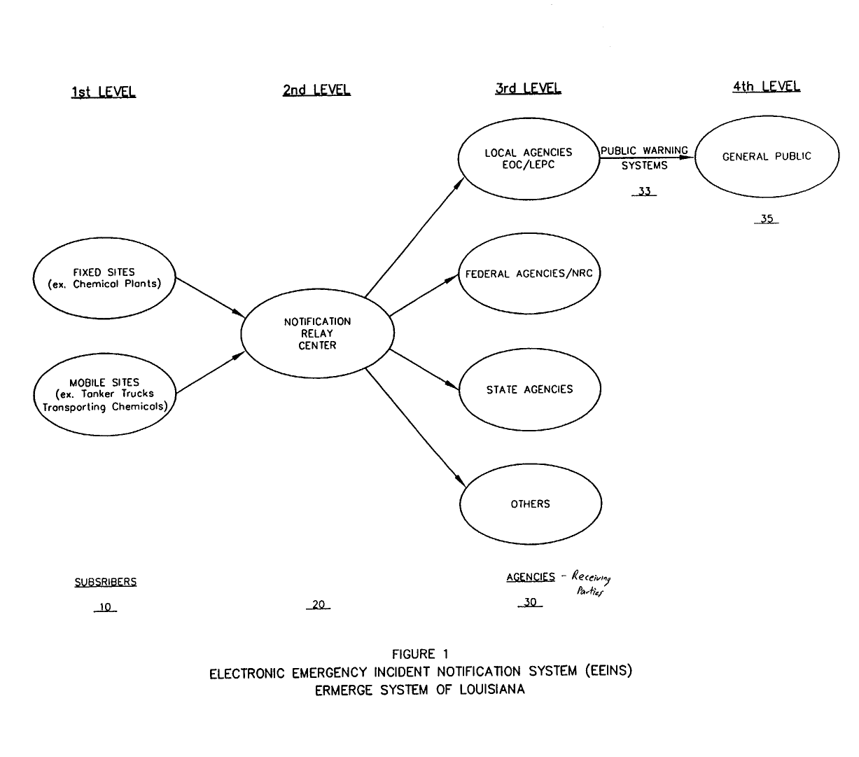

Referring to the drawings in more detail, the general structure of the EEINS is shown in FIG. 1. The system is, in its most basic form, comprised of three layers. The first layer 10 involves the subscribers. The subscribers are the industrial sites which may need to report a nuclear, chemical, or biological release to various agencies. These industrial sites may be either fixed, such as industrial plants, or mobile (utilizing wireless technology), such as vehicles for transporting substances. The second level 20 is the notification relay center, through which all of the subscribers' notifications are funneled and then directed to the appropriate receiving parties (such as government agencies). The third level 30 involves the receiving parties, primarily agencies, which may need to be notified in the event of an incident. This may include local response, such as the local EOC/LEPC for the affected area, the NRC for notifying federal agencies, the EPA, the state environmental agency (such as DEQ), the state police, and others (such as HazMat response units). The local EOC/LEPC may also activate the public warning systems 33 for the affected area, in order to warn the general public (designated the optional fourth level 35 of the EEINS).

This general structure can be implemented in several different ways. For example, several different types of communications means could be used to enable the subscribers of the first level 10 to communicate with the notification relay center of the second level 20. Similarly, several different types of communications means could be used to enable the notification relay center of the second level 20 to transmit notice to the appropriate agencies of the third level 30. Such communications means include but are not limited to phones, facsimile machines, modems, the Internet/world-wide-web, and wireless communications devices. In the preferred embodiment, the Internet is the primary communications means both between the subscribers of the first level 10 and the notification relay center of the second level 20, and between the second level 20 and the agencies of the third level 30.

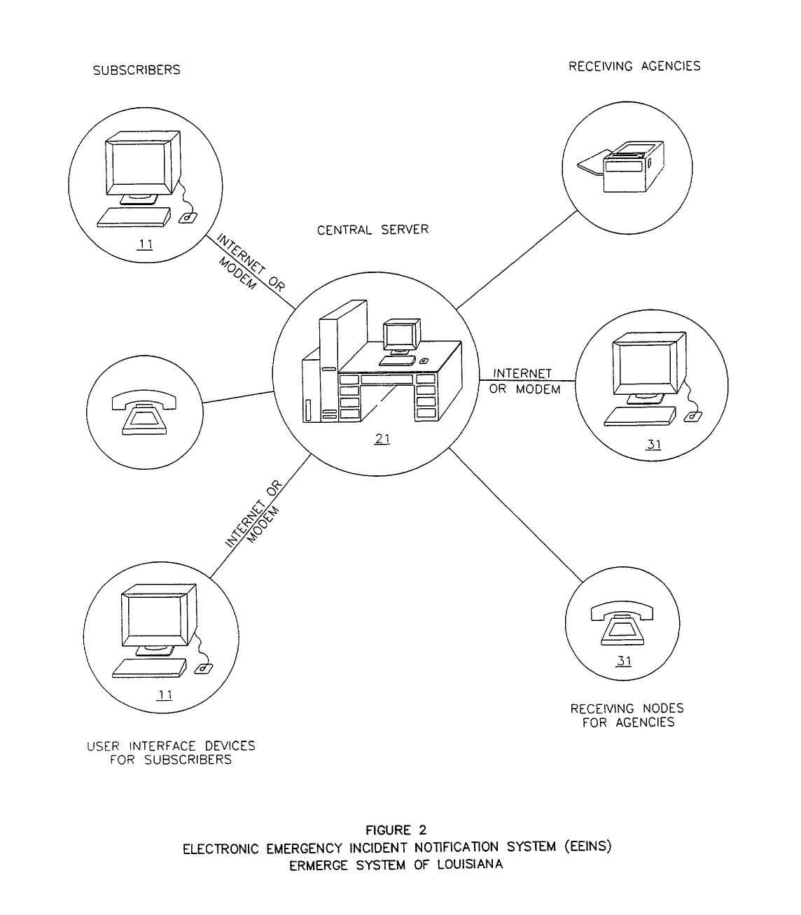

FIG. 2 graphically illustrates a preferred embodiment of the EEINS. The subscribers of the first level 10 utilize user interface devices 11 in order to transmit information about an incident to the notification relay center of the second level 20. In the preferred embodiment, the notification relay center is a central server 21 which operates on the Internet. The central server 21 typically includes a web site with a web page allowing subscribers to report incidents, one or more databases (for example, a GIS database), software for integrating the input data with the GIS database, and one or more means for notifying the appropriate agencies. The receiving agencies of the third level 30 each have a receiving node 31 through which the central server may contact the agency. Optionally, the receiving node 31 for an agency may include a GIS database. Thus, in the preferred embodiment, the subscriber utilizes the user interface device 11 to interact with the central server 21 over the Internet, and the central server 21 processes the information provided by the subscriber and transmits notice to the receiving nodes 31 for the appropriate agencies.

Upon subscription to EEINS, the subscriber would create an account with the central server 21. Typically, the account would be accessed using a user identification name or number and a password, to ensure that only the actual subscriber would have access to their account on the central server 21. The subscriber may also pre-set some of the elements within the notification report to provide defaults in order to speed the reporting process during an actual emergency incident. For example, the subscriber would enter their name and address, so that the central server 21 would have the appropriate GIS database information on hand for the particular subscriber site. The subscriber could also pre-set the default location of the grid for identifying the spatial information for the affected area, the type and size of grid, and the size of any buffer zone in relation to the spatial information, for example.

When an incident occurs, the subscriber would access the central server 21 using an interface device 11. In the preferred embodiment, the interface device 11 would be a standard personal computer with a web browser, enabling the subscriber to link to the central server 21 using the Internet. The subscriber would enter the URL address to go to the home page of the central server 21 on the Internet. There, the subscriber would be prompted to enter their user identification name or number and password. Upon successful entry of the user identification name or number and password, the central server 21 would automatically access the information in its database to retrieve geographic information for the area of the subscriber's site. Typically, this information is provided in graphical form in order to be user friendly and easy to operate. The central server 21 would also retrieve any pre-entered information, such as defaults, from its database.

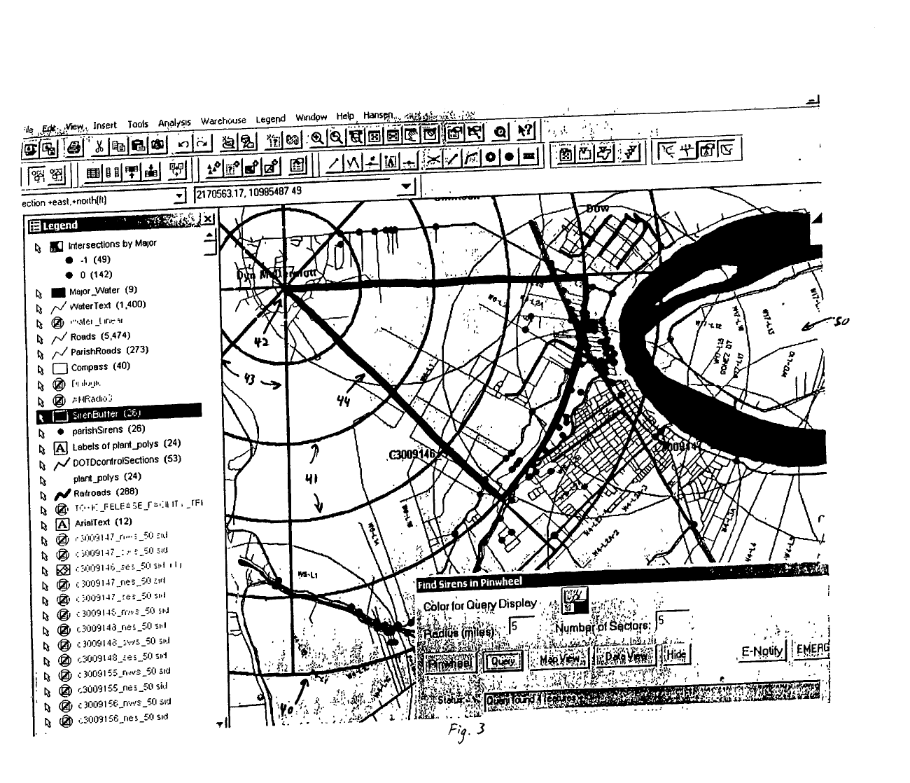

The subscriber would then be directed to a web page, an example of which is shown in FIG. 3, with the geographical information displayed for review by the subscriber. The subscriber may then drop a grid 40 onto the graphical rendition of the geographic information, by selecting the center point 42 and size for the grid 40, or else may rely upon pre-selected/default grid 40 information. While any sort of grid 40 may be used, in the preferred embodiment, a pinwheel grid 40 of concentric circles 41 segmented by evenly spaced radial lines 43 is utilized. The default setting in the preferred embodiment typically divides the concentric circles 41 of the pinwheel grid 40 into eighths.

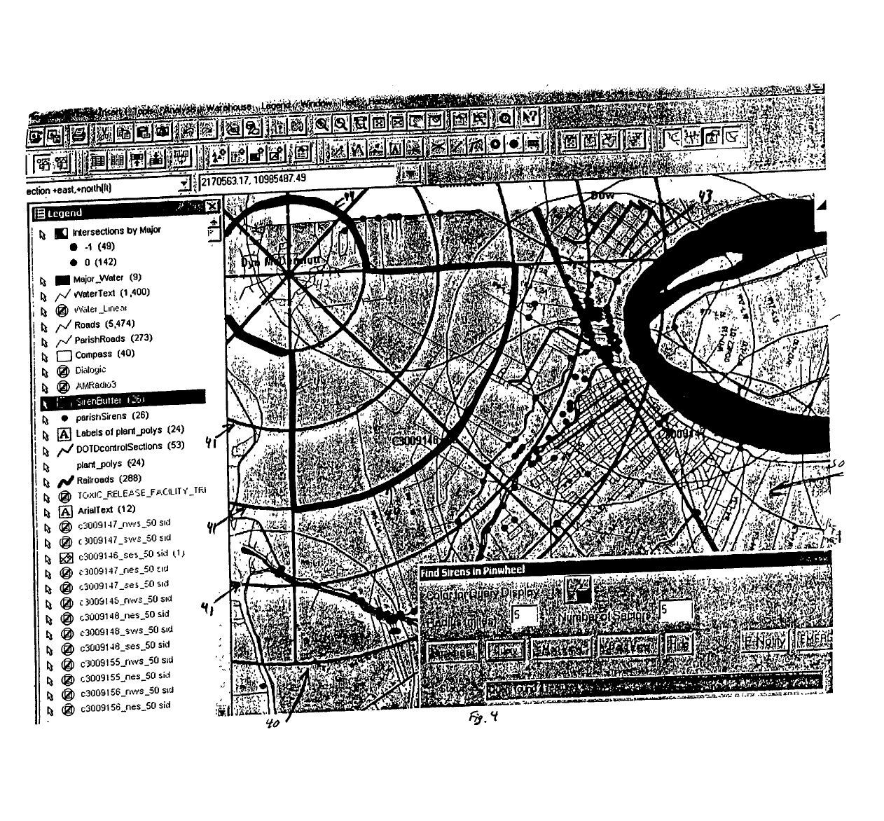

Once the subscriber has dropped a properly sized pinwheel grid 40 onto the background geographic information 50, displayed in map form in the preferred embodiment, the subscriber must select the polygon 44 of the affected area of the incident for notification. This polygon 44 will mark the spatial geometry (boundaries) of the incident within the GIS database of the central server 21. In the preferred embodiment, the subscriber selects the polygon 44 by mouse clicking on the appropriate segments of radial lines 43 and segments of concentric circles 41 to border an area of the map 50 showing the affected area of the particular incident. This graphical procedure for indicating the affected area of an incident is only one such means for providing spatial data to the central server 21 for mapping onto its GIS database. Any means for providing this information (including providing numerical coordinates) may be used. The shape of the polygon 44 will depend entirely upon the circumstances of a particular incident, and need not be limited to a simple (pie-shaped) arc. See for example, the polygon 44 of FIG. 4, in which the subscriber has marked a small circular area around the center point 42 by clicking on several segments of one of the concentric circles 41 and has also indicated an arc extending outward in one direction by clicking on several segments of radial lines 43 and several segments of another of the concentric circles 41.

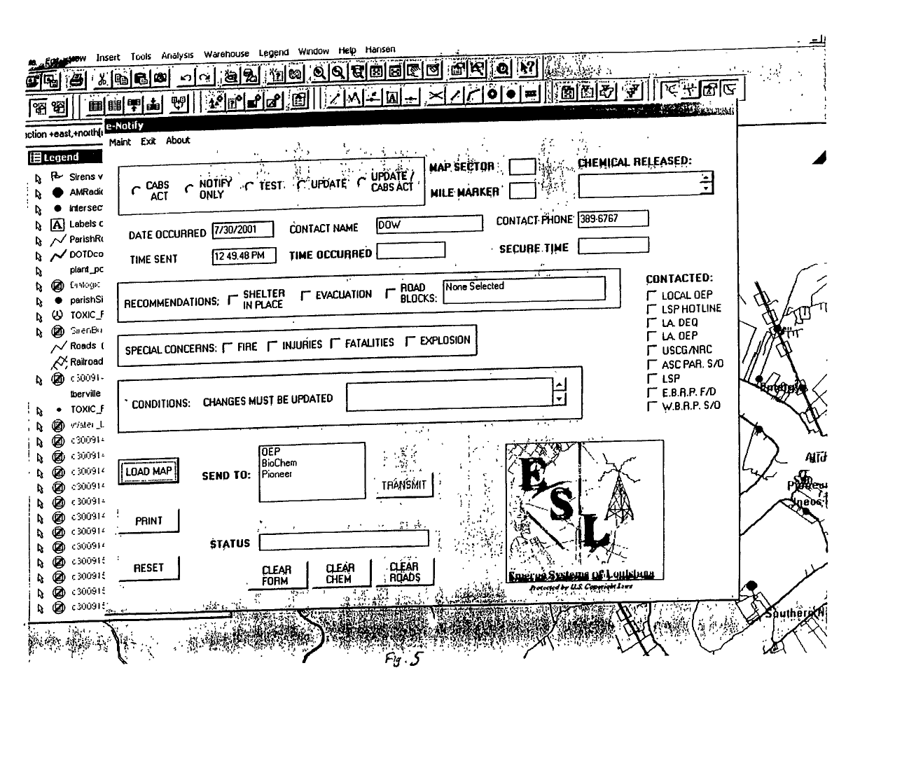

After the subscriber has indicated the polygon 44 of the affected area, the subscriber may optionally also indicate recommended road closures on the background map 50 (or this information may be entered in textual form later). Then, the subscriber will be directed to a web page/window, an example of which may be seen in FIG. 5, for the incident report form. The subscriber must complete the form information for this incident report, providing any non-spatial data that the agencies require in order to properly and effectively respond to the incident at issue. For example, the subscriber may indicate on the incident report form which type of event is occurring (nuclear, chemical, or biological), which specific chemicals have been released, the time of the incident, the conditions present at the site of the incident, any special concerns of which emergency personnel may need to be made aware (such as fire, injuries, fatalities, or explosions), and any recommendations the subscriber may wish to offer (such as evacuations and road closures). Upon completing the incident report web page of FIG. 5, the information is typically verified and is then released to the central server 21 for simultaneous transmission/dissemination to all appropriate agencies.

Once the verified incident report has been entered by the subscriber, the central server 21 maps the polygon 44 with the spatial information regarding the affected area entered by the subscriber onto its GIS database to determine which agencies should be notified. In addition to the area of the polygon 44, the central server 21 may also utilize a pre-selected buffer zone so that agencies whose physical jurisdiction lies slightly outside of the polygon 44 selected by the subscriber can also be notified. The GIS database typically includes geographic/spatial data about the physical jurisdiction of receiving parties such as EOC/LEPC, police, fire departments, and EMS, along with data about state borders, county/parish lines, city boundaries, and important geographic features such as rivers and roads. The central server 21 may also record the information provided by the subscriber in a separate database so that it may later be reviewed by the subscriber and/or by agencies for analysis.

In the preferred embodiment, the central server 21 uses the polygon 44 of spatial data provided by the subscriber in conjunction with the information about agencies located within its GIS database to identify the agencies to receive notification of the incident. Any local/municipal/county/parish agency whose geographic jurisdiction crosses the polygon 44 will be selected, along with any state agencies for states which include any of the area of the polygon 44 and any federal agencies. All agencies identified by the central server 21 as being located within the context of the polygon 44 identified as the affected area of the incident by the subscriber are then notified of the incident via the appropriate means.

Different agencies will have different capabilities for receiving notification, and the EEINS must be equipped to notify the appropriate agencies regardless of their chosen means for notification. As a result, the preferred embodiment of the EEINS includes multiple methods for transmitting incident reports to agencies. The GIS database for the central server 21 will include information about the appropriate means for contacting the agency, so that the incident report may be transmitted to the agency using the required means. The most basic means for notifying an agency of an emergency incident in the preferred embodiment utilizes fax capabilities. When an agency requires notification by facsimile, the central server 21 may translate the data entered by the subscriber on the web page for the incident report into textual form for transmission to the appropriate agency at the listed fax number. Telephone communication could also be used.

The preferred method of transmitting incident reports to agencies, however, would utilize the Internet. In the preferred embodiment, the receiving agency has a receiving node 31, typically a dedicated computer, for receiving notification of incidents, and the central server 21 transmits the incident report, along with all of the relevant spatial data of the polygon 44 selected by the subscriber, to the agency using the Internet. In the preferred embodiment, this is accomplished using a demon process to establish communication with the receiving node 31 at the appropriate agency. Typically, the receiving node 31 would then acknowledge receipt of the incident report and spatial data by transmitting a signal back to the central server 21. The agency can then review the incident report to determine if the reported incident is of the type to which they respond. This may be done electronically, by having the receiving node 31 review the appropriate fields within the incident report to determine if they match the qualifying factors for the agency at issue, or manually.

Optionally, the receiving agency may also have the receiving node 31 equipped with a GIS database. The GIS database for a specific receiving node 31 would contain a specific agency's geographic information, so that the agency could use the polygon 44 of spatial data regarding the area of the incident to determine how the incident interacts with the agency's special concerns. For example, the EPA's GIS database might contain information about the geographic location of various animal habitats. Upon receiving notification of an incident from the central server 21, the receiving node 31 would map the spatial data of the polygon 44 of the incident onto its GIS database in order to determine which specific animal habitats being monitored by the EPA are threatened by the incident. This would allow the EPA to quickly determine the appropriate type of response to the incident. Similarly, the Interior Department might utilize a GIS database showing the location of various Native American reservations, so that the Interior Department could quickly determine whom to notify regarding an incident. Also, local response units (such as HazMat or State Police) might utilize a GIS database showing the location of pre-positioned emergency response equipment/personnel, so that the equipment/personnel can be optimally employed to address the incident.

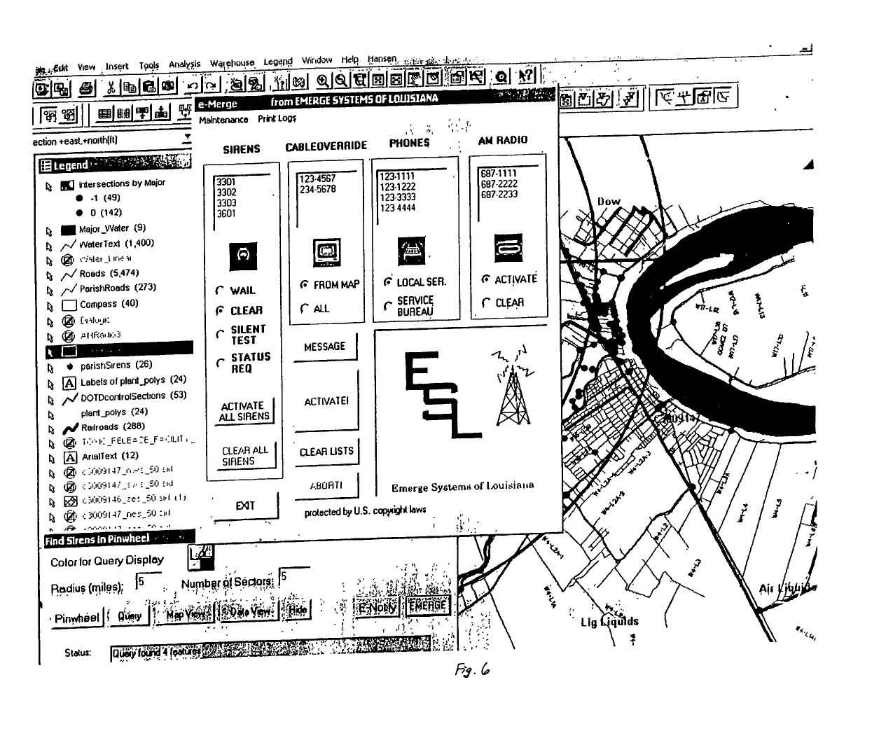

Another such use would be a receiving agency with a receiving node 31 equipped with a GIS database and software which integrates the agency's public warning systems with the EEINS. In that case, the spatial data of the polygon 44 designating the affected area of the incident, which is transmitted with the incident report, would be used by the receiving node 31 to activate the public warning systems within the appropriate area, so that the proper segments of the general public receive the warning along with any official instructions. In the preferred embodiment, the receiving agency uses software on the receiving node 31 to enter a single message for transmission over the various emergency public warning systems, such as radio and cable television overrides and telephone call-ups, and the EEINS automatically and simultaneously activates all of these public warning systems, including sirens if available, within the designated area of the incident. FIG. 6 provides an example of such software interface on the receiving node 31. This type of optional system would most typically be utilized by local EOC/LEPC, since they are typically the agencies charged with actual notification of the general public.

While a centralized GIS database system (with detailed information from all agencies input into the GIS database of the central server 21) could also be used, a distributed GIS database system has several advantages which make it the preferred embodiment. First, a distributed GIS database speeds the notification process since the central server 21 need only transmit the polygon 44 of spatial data (along with a brief, general incident report) to each agency, rather than having to generate and transmit a lengthy, agency-specific report to each receiving node 31. Second, a distributed GIS database system allows each agency to update its information and to change its informational queries independently. Finally, a distributed system is more robust, since a failure at one receiving node 31 will have no impact on other receiving nodes 31. For these reasons, a distributed GIS database system is favored.

The receiving node 31 of a host agency could also be arranged to act as a regional nexus for local agencies to receive notification. In that case, the receiving node 31 would include a GIS database. The polygon 44 and incident report would be mapped onto the GIS so that local agencies would be able to determine if the incident falls within their jurisdiction. The local agencies would then receive a report of an incident from the receiving node 31, and would be able to log onto the receiving node 31 in order to determine if they need to respond to the reported incident. Thus, there may be multiple levels of receiving agencies notified by the EEINS using a hierarchal system.

Obviously, given the important nature of the notification services, backup systems and redundancy will be important to ensure smooth operation. This includes a back-up power source for the central server 21, one or more back-up means for receiving data from the industrial subscribers, and one or more back-up means for transmitting the data to the receiving agencies. Such back-up communications means may include dial-up modems, facsimile transmissions, or telephones. Furthermore, in order to ensure that the primary Internet communications means is available and functioning, the central server 21 in the preferred embodiment may periodically check to verify that the receiving nodes 31 at the various agencies are on-line and ready to receive transmissions. If a receiving node 31 is not on-line at the time of an incident, or if the receiving node 31 does not acknowledge receipt of the incident report, then the central server 21 will automatically utilize a back-up means to communicate data about the incident to that receiving agency.

Additionally, subscribers may provide updated details on a periodic basis throughout the course of an incident, in order to ensure that the receiving agencies are kept apprised of changes and/or corrections. For example, if the release in question is continuing and/or the wind changes direction, the affected area may enlarge or change location. Thus, the subscriber would be able to access the central server 21, as described above, and to alter the configuration of the polygon 44. The central server 21 would then notify the appropriate receiving agencies (which may include some additional agencies which were not originally covered by the polygon 44 as initially input by the subscriber) of the updated information. Likewise, the subscriber may learn more about the incident, such as the specific type of chemical released and/or whether special conditions such as fire or injuries exist, and may provide updated information to the receiving agencies via the EEINS. Finally, this information update could also be stored by the central server for later analysis.

In the preferred embodiment, the central server 21 simultaneously notifies the NRC (which must by law receive notice of certain types of releases so that it can then decide upon a federal response and notify the appropriate federal agencies), one or more local EOC/LEPC for the affected area (which typically are charged with deciding upon an emergency response, notifying the appropriate local emergency response personnel, and notifying the general public, if necessary), and any state agencies (such as the state environmental department and the state police) which require notification. The central server 21 may also notify other local agencies and even other subscribers within the affected area; any appropriate receiving parties may be automatically notified of the reported emergency incident by the central server 21.

Although the basic structure of the EEINS described above applies to fixed industrial sites, the concept of the EEINS applies equally well to mobile sites with only slight modification. Indeed, the ability to integrate emergency notification for both fixed and mobile sites is a significant advantage of the EEINS. A great deal of transportation of regulated substances between fixed sites occurs on a daily basis. These regulated substances are transported using many different means, including tanker trucks, tanker cars on trains, barges, and ships. If there is a release of a regulated substance during transport, it would be helpful if the subscriber could immediately and simultaneously notify the appropriate agencies.

This can be accomplished using the EEINS by simply providing a user interface device 11 aboard the transport vehicle. For a mobile site, the user interface device 11 would need to include a wireless communications device, such as wireless Internet access, so that the subscriber at the mobile site will be able to access the central server 21 regardless of location. In addition, the user interface device 11 would need to include a GPS device, so that the subscriber will be able to direct the central server 21 to the proper background map 50, and so that the subscriber can drop the pinwheel grid 40 in the appropriate location. Once the central server 21 has used the GPS information to locate a grid 40 upon the proper background map 50, the subscriber will proceed in the manner described in detail above (i.e. select a polygon 44 to estimate the affected area, recommend road closures, complete an incident report, verify the information and transmit the incident report with spatial data to the central server 21 for distribution to the receiving nodes 31 at the appropriate agencies).

Obviously, the EEINS could be applied to other types of incidents as well. The EEINS is particularly well-suited to handle any sort of notification with geographic elements, where such notice needs to be sent to several different recipients for simultaneous, concerted action. For example, it could be integrated into current systems for alerting agencies about terrorists threats and attacks, so that any information relating to terrorist activities could be quickly transmitted to all relevant agencies for immediate response. Likewise, it could be used to notify emergency response agencies of natural disasters. The primary difference in such incidents would be that the affected area might have to be estimated based upon second hand reports rather than directly input by subscribers in the affected area. Of course, mobile units could be located on police and/or emergency response vehicles for more immediate input.

Although the EEINS could be used as a regional notification system (with a central server 21 servicing only subscribers within a limited area, and perhaps utilizing many different central servers 21 for different geographic regions across the nation), in the preferred embodiment, the EEINS would be an integrated, national notification system. In such a system, the central server 21 would include GIS information for the entire United States, and all notifications from subscribers within the United States would be channeled through a single central server 21 for distribution to the appropriate agencies. This type of national system is better suited than a regional system when mobile sites are involved, since there would be no need for mobile subscribers to determine the appropriate regional central server 21 to which notification should be directed (since there is only one central server 21, and all notifications are directed to a single Internet web site). In the preferred embodiment, mirrored units would be used for the central server 21 since this would improve the speed of access and would provide an automatic backup should one unit crash for any reason.

The EEINS offers substantial benefits over the current notification system by improving both the speed and accuracy by which industries may notify agencies of incidents. These improvements are the result of both the organizational flow of the system and the use of integrated communications and informational systems. The specific embodiments and uses set forth herein are merely illustrative examples of the preferred embodiments of the EEINS invention and are not intended to limit the present invention. A person skilled in the field will understand and appreciate additional embodiments and uses, which are also included within the scope of the present invention.

What I claim is:

1. An emergency notification system comprising:
an incident report;
a notification relay center further comprising one or more databases;
a means for transmitting an incident report regarding an emergency incident at a subscriber site to said notification relay center; and
a means for said notification relay center to notify any appropriate receiving parties of said emergency incident.

2. An emergency notification system as in claim 1 wherein said notification relay center further comprises a means for identifying said appropriate receiving parties which should be notified regarding said emergency incident.

3. An emergency notification system as in claim 1 wherein said incident report further comprises spatial data regarding the affected geographic areas of said emergency incident and non-spatial data regarding said emergency incident.

4. An emergency notification system as in claim 2 wherein said incident report further comprises spatial data regarding the affected geographic areas of said emergency incident and non-spatial data regarding said emergency incident.

5. An emergency notification system as in claim 4 wherein said non-spatial data of said incident report further comprises one or more of the following:
a time and date stamp which indicates the time and date that said incident report is transmitted to said notification relay center;
the identity and/or address of the site of said emergency incident;
the identity of the reporting party;
contact information for the reporting party;
a list of chemicals released at the site;
a list of biological agents released at the site;
a warning of any nuclear or radioactive release at the site;
a list of special concerns for emergency response personnel such as whether there is any fire, injuries, fatalities, or explosions at the site; and
a description of any recommendations which the reporting party would like to offer to emergency response personnel.

6. An emergency notification system as in claim 2 wherein said means for transmitting an incident report further comprises a user interface node which is located at said subscriber site and which may electronically transmit data.

7. An emergency notification system as in claim 6 wherein said user interface node is further comprised of a facsimile machine and an incident report form.

8. An emergency notification system as in claim 6 wherein said user interface node is further comprised of a data input device, a visual data display, and an electronic data transmission means.

9. An emergency notification system as in claim 6 wherein said user interface node further comprises an internet-capable personal computer.

10. An emergency notification system as in claim 1 wherein said database of said notification relay center is further comprised of a GIS database.

11. An emergency notification system as in claim 4 wherein said database of said notification relay center is further comprised of a GIS database, and wherein said means for identifying said appropriate receiving parties further comprises a computer-operated program which maps said spatial data from said incident report onto said GIS database.

12. An emergency notification system as in claim 10 wherein said GIS database houses geographic information regarding one or more of the following:
subscriber site locations being monitored;
jurisdictional boundaries of various receiving parties;
geographic boundaries of states, counties/parishes, cities, and other political subdivisions; and
locations of roads, rivers, railroad lines, and population centers.

13. An emergency notification system as in claim 10 wherein said one or more databases of said notification relay center further comprises a database with information regarding one or more of the following:
the appropriate means for notifying each receiving party,
the user identification number and password for each subscriber site,
the pre-set defaults on the incident report set by each subscriber site, and
the location of each subscriber site.

14. An emergency notification system as in claim 13 wherein said GIS database houses geographic information regarding one or more of the following:
subscriber site locations being monitored;
jurisdictional boundaries of various receiving parties;
geographic boundaries of states, counties/parishes, cities, and other political subdivisions; and
locations of roads, rivers, railroad lines, and population centers.

15. An emergency notification system as in claim 9 wherein said notification relay center is further comprised of a central server, and wherein said central server is further comprised of a GIS database and an internet accessible webpage for submitting an incident report.

16. An emergency notification system as in claim 15 wherein:
said GIS database houses geographic information regarding the jurisdictional boundaries of receiving parties; and
said notification relay center further comprises a database with information regarding the appropriate means for notifying each receiving party.

17. An emergency notification system as in claim 16 further comprising a receiving node located at each receiving party.

18. An emergency notification system as in claim 17 wherein said incident report further comprises
spatial data regarding the affected geographic areas of said emergency incident and non-spatial data regarding said emergency incident, and wherein a subscriber at a subscriber site may report an emergency incident by using said user interface node to access said webpage of said central server to complete and transmit an incident report to said central server;
said central server maps said spatial data onto said GIS database to determine the appropriate receiving parties for notification by determining which receiving parties' jurisdictional boundaries intersect with said spatial data of the affected area of said emergency incident; and
said central server transmits a notification signal to said receiving nodes at said appropriate receiving parties.

19. An emergency notification system as in claim 18 wherein said notification signal further comprises said spatial data, and wherein said receiving node further comprises a database concerning available public warning systems and a computer-operated program which allows for integrated activation of appropriate public warning systems based upon said spatial data.

20. An emergency notification system as in claim 2 wherein said means for transmitting an incident report further comprises a global positioning system and wireless communication capabilities.

21. An emergency notification system as in claim 6 wherein said user interface node further comprises a global positioning system and wireless communication capabilities.

22. An emergency notification system comprising:
one or more user interface nodes with internet access;
an internet-accessible central server having one or more databases; and
one or more receiving nodes located at receiving parties which may need to be notified in case of an emergency incident.

23. An emergency notification system as in claim 22:
wherein said central server further comprises a webpage for submission of an incident report; and
wherein at least one of said databases of said central server is a GIS database.

24. An emergency notification system as in claim 23 wherein one or more of said user interface nodes further comprises a global positioning system and wireless communication capabilities.

25. An emergency notification system as in claim 23:
wherein said incident report further comprises spatial data concerning the location and area of an emergency incident, and non-spatial data concerning said emergency incident;
wherein said central server further comprises one or more means for communicating with said receiving nodes; and
wherein said GIS database houses geographic information regarding the jurisdictional boundaries of various receiving parties.

26. An emergency notification system as in claim 25 wherein said non-spatial data of said incident report further comprises a list of any chemicals, biological agents, or nuclear or radioactive elements released at the site.

27. An emergency notification system as in claim 25 wherein one or more of said user interface nodes further comprises a global positioning system and wireless communication capabilities.

28. An emergency notification system as in claim 26 wherein a subscriber may submit an incident report regarding an emergency incident at a subscriber site by accessing said webpage of said central server using said user interface node, wherein said subscriber designates said spatial data of said incident report using a graphical interface by dropping a grid onto a map of the area around said subscriber site and selecting the sections of said grid affected by said emergency incident, and wherein said subscriber enters said non-spatial data of said incident report into a form on said webpage.

29. An emergency notification system as in claim 28 wherein said central server maps said spatial data onto said GIS database in order to determine which receiving parties to notify, and designates receiving parties as appropriate for notification if said receiving parties' jurisdictional boundaries intersect with said spatial data identifying the affected area of the incident.

30. An emergency notification system as in claim 29 wherein said central server notifies all designated appropriate receiving parties by transmitting a notification signal to said receiving nodes at said designated appropriate receiving parties.

31. An emergency notification system comprising:
an internet-accessible webpage which allows subscribers to log onto said emergency notification system and to enter an incident report concerning an emergency incident;
a GIS database;
a means for selecting appropriate receiving parties for notification regarding said emergency incident; and
one or more means for notifying any selected appropriate receiving parties.

32. An emergency notification system as in claim 31 wherein said incident report further comprises spatial data defining the affected area of said emergency incident.

33. An emergency notification system as in claim 32 wherein said means for selecting appropriate receiving parties for notification further comprises a computer-operated program which maps said spatial data of said incident report onto said GIS database.

34. An emergency notification system as in claim 32 wherein said GIS database houses geographic information regarding the jurisdictional boundaries of said receiving parties.

35. An emergency notification system as in claim 34 wherein said means for selecting appropriate receiving parties for notification further comprises a computer-operated program which maps said spatial data of said incident report onto said GIS database, wherein any receiving party whose jurisdictional boundaries intersect with said spatial data is selected for notification.

36. A method for notifying receiving parties of emergency incidents comprising the steps of:
receiving an incident report from a subscriber site regarding an emergency incident;
determining the appropriate receiving parties which should be notified of said emergency incident based upon the location and affected area of said emergency incident and the jurisdictional boundaries of said receiving parties; and
transmitting a notification signal to said appropriate receiving parties.

37. A method as in claim 36 wherein said incident report further comprises spatial data defining the affected area of said emergency incident, and wherein information regarding the jurisdictional boundaries of said receiving parties is maintained within a GIS database.

38. A method as in claim 37 further comprising the steps of:
mapping said spatial data onto said GIS database; and
selecting any receiving party whose jurisdictional boundaries intersect with the area defined by said spatial data as an appropriate receiving party to receive a notification signal.

39. A method as in claim 38 further comprising the step of designating said spatial data of said incident report using a graphical interface by dropping a grid onto a map of said subscriber site and selecting the sections of said grid affected by said emergency incident.

40. A method as in claim 38 further comprising the steps of:
determining the appropriate communications means for transmitting a notification signal to each appropriate receiving party; and
selecting the appropriate communications means for each appropriate receiving party.

41. A method as in claim 38 further comprising the step of automatically activating any public warning systems controlled by each appropriate receiving party.

42. A method as in claim 38 further comprising the step of utilizing a global positioning system to designate the location of said emergency incident.

43. A method for reporting an emergency incident comprising the steps of:
submitting an incident report with spatial and non-spatial data regarding an emergency incident at a subscriber site;
mapping said spatial data onto a GIS database having information concerning the jurisdictional boundaries of agencies;
selecting appropriate agencies for notification by determining which agencies' jurisdictional boundaries intersect said spatial data;
transmitting a notification signal to said appropriate agencies.

44. A method as in claim 43 further comprising the step of activating any public warning systems located at said appropriate agencies.

45. A method as in claim 43 wherein subscribers submit said incident report via the internet by accessing a webpage on a central server.

46. A method as in claim 45 further comprising the steps of:
dropping a grid onto a map of the area around the subscriber site; and
selecting the sections of said grid which cover the affected area of said emergency incident in order to designate spatial data for said incident report.

47. A method as in claim 46 further comprising the steps of:
accessing a database of contact information for agencies to determine the proper communications means for transmitting said notification signal to each appropriate agency;
selecting the proper communications means for transmitting said notification signal for each appropriate agency; and
verifying receipt of said notification signal by said appropriate agencies.

48. A method as in claim 46 further comprising the steps of:
utilizing a global positioning system to determine the location of said subscriber site; and
utilizing wireless internet capabilities to submit said incident report.
